(19) United States
(12) Patent Application Publication
(10) Pub. No.: US 2013/0160120 A1
(43) Pub. Date: Jun. 20, 2013

(54) PROTECTING END USERS FROM MALWARE USING ADVERTISING VIRTUAL MACHINE

(71) Applicants: Paritosh Malaviya, Sunnyvale, CA (US); Gajendra Nishad Kamat, Bangalore (IN)

(72) Inventors: Paritosh Malaviya, Sunnyvale, CA (US); Gajendra Nishad Kamat, Bangalore (IN)

(73) Assignee: YAHOO! INC., Sunnyvale, CA (US)

(21) Appl. No.: 13/331,523

(22) Filed: Dec. 20, 2011

(51) Int. Cl. G06F 12/14

(52) U.S. Cl. 726/23

(57) ABSTRACT

Techniques are disclosed for an AdVM (Advertising Virtual Machine) system, modules, components and methods that provide multiple layers of ad security for end-users. AdVM browsers isolate, monitor and restrict ads in sandboxes. AdVM browsers are configurable to monitor, report abuse and restrict ad performance based on configurable parameters such as system usage, security, privacy, inadvertent clicks, required ad ratings, permissions (whitelisting) and denials (blacklisting). AdVM browser abuse reports are used to generate profiles, whitelists and blacklists for ads, advertisers and other ad participants, which AdVM browsers use to allow or deny ad performances. Publishers assist AdVM browsers with ad detection by declaring ads in content. Ad security is improved by participation of advertisers, ad networks and an ad quality authority in creating trusted or rated ads that can be selected and verified over untrusted or unrated ads. Improving end-user trust in online advertising protects both end-users and legitimate online advertising.

### BACKGROUND OF THE INVENTION

1. Field of the Invention

The present invention relates to techniques for protecting end users from malware.

2. Background

In a computer networking environment such as the Internet, users commonly use their computers to access other computers (e.g. servers) containing resources of content providers on the “World Wide Web” (i.e. “the Web”) to obtain various types of content (e.g. text, images, video). Content providers themselves may publish content on their own Webpages and/or they may provide content to other publishers (e.g. Webpage providers). As a common revenue source, publishers publish advertisements (i.e. ads) along with content. Like content, ads may originate from sources other than a publisher, including first and third party ad servers that select from among many ads provided by many advertisers. Some well-known content and ad publishers who also provide search engine services include Yahoo! Search™ (at http://www.yahoo.com), Microsoft Bing™ (at http://www.bing.com) and Google™ (at http://www.google.com). Yahoo! is one of the world's largest online publishers, advertising networks and advertising exchanges, which connects advertisers and publishers. For example, Yahoo!'s Right Media advertising exchange may have more than 400,000 active advertising creatives available for publication on any given day while Yahoo! delivers approximately 21 billion ad impressions per day.

For each ad impression, there are multiple opportunities to download malware onto end-user computers. Online advertisements often combine Hyper-Text Markup Language (HTML), JavaScript or ActionScript code, image or Flash files, tracking activity such as sending beacons to advertisers or ad network servers, ad call redirects, etc. This can effectively open the floodgates to malicious exploitation of end-users and their computers. Accordingly, malware is increasingly being distributed through advertising channels. Malvertising refers to malicious advertising, such as where advertising is used as a delivery vehicle to disseminate malware or otherwise intentionally or unintentionally harm an end-user's interests. Malicious encompasses both unethical and malicious behavior that automatically harms end users or attempts to trick end users into manually assisting in harming themselves. Examples of malicious, harmful or abusive activity include cookie or JavaScript abuse, downloadable exploits (e.g. pdf downloads, active), popups, phishing, rogue access points, document object model (DOM) infringements that result in theft or other abuse of privacy or other forms of subterfuge, unintentional abuse of end-user computer resources such as mobile power or bandwidth. Malvertisers may be motivated to defraud or extort money from end-users, steal personal information (e.g. bank account or credit card information) in order to steal money, and/or generate traffic to websites to generate advertising income. As one example, a common trick employed by malvertisers is a false warning (e.g. in a fake Windows dialog box) that an end-user's computer is infected and that the end-user should download and even pay for the malvertiser's “solution.” An end-user may be tricked into downloading “free” or for a fee the “solution,” which may do nothing more than temporarily stop the dishonest warning or it may download malicious software. As another example, infected pdf or Flash files may be loaded by an advertising creative. Arbitrary code may then be executed utilizing techniques such as buffer overflows. As yet another example, legitimate ads on legitimate publisher websites may be tampered with so that when loaded into a browser on an end-user computer a tampered advertisement may make hundreds of background calls to one or more websites to generate fake page views. The point being that malvertisers relentlessly commit fraud, extortion and other economic crimes in new, mischievous ways every day at the great expense and frustration of legitimate online participants.

Yahoo! and millions of other publishers, ad networks, ad exchanges, advertisers and other legitimate online participants have a vested interest in avoiding the publication of malicious content and ads to their audience (e.g. end-users or consumers). Malicious content and advertisements are harmful to all legitimate online industry participants. With respect to publishers, malicious content and advertisements may reduce the publisher's audience, reduce advertising impressions and reduce revenue.

One difficulty in detecting and preventing malvertising is that online advertising involves active, dynamic, conditional and interactive content that may react differently to different end-user computers having different security software and different browsers with different extensions, plug-ins and vulnerabilities. Another difficulty is that malvertisments may be difficult to detect if they change over time (e.g. alternate between benign and malicious behavior based on periodic time, random time or detection of target audience). Malvertisements may detect ad content testing and avoid malicious activity to evade detection. Malvertisements may use new or different domains for malvertising campaigns to avoid blacklisted domains. Malvertisements may obfuscate malicious activity in code such as string manipulation operations in JavaScript. Malvertisements may deliver malicious code in pieces for subsequent or delayed combination. Malvertisements may inject malicious code into files that end-users approved for downloading, e.g., JavaScript script injects malicious code into a .pdf file approved for download. Malvertisements may access rogue access points such as IP addresses to download files that are initially benign or non-existent, but subsequently malicious, such as a malicious program designed to turn computers into zombies. For these and other reasons, some malvertisements are particularly difficult to detect and prevent by ad content testing. This advertising problem stands in stark contrast to passive advertising on television, radio and other mediums.

Another difficulty in detecting and preventing malvertising is third party serving of malvertisements where a malvertising creative is unknown and unavailable for testing in advance of publication. An advertising creative (creative) may comprise a tag (e.g. an HTML or JavaScript fragment), which is downloaded in response to an advertising call from a browser. In accordance with the ad tag, a browser then downloads actual creative content (e.g. text, image file, Flash file) from a third party creative content server. Creative tags and creative content may not be owned by the same ad network or exchange. Sometimes an ad server owns a creative tag while creative content is owned by a third party content server. Sometimes an ad server is a mere proxy that, in response to an ad call from a browser, makes an ad call to a third party server to determine what creative content will be served to the browser in accordance with the returned creative tag, which could result in downloading content from anywhere in the world. The numerous variations of redirected/delegated ad calls and creative content sourcing within and between numerous ad networks ads layers of complexity in finding, testing, discovering and preventing the dissemination and publication of malvertisements.

FIG. 1 is a simplified illustration of the prior art with regard to online advertising. Advertising system 100 comprises multiple ad networks, publishers, advertisers and end-users communicatively coupled to network 102 (e.g. Internet). There may be many more advertising networks, publishers, advertisers and end-users than shown in FIG. 1. Advertising system 100 illustrates multiple advertising networks, e.g., ad network A 104 and ad network N 106, available to provide ads to publisher A 108, publisher N 110 and/or directly to browser A 112 and browser N 114. Each of browser A 112 and browser N 114 may comprise an end-user computer executing a browser application at the direction of a user (not shown). Each of advertiser A 116 and Advertiser N 118 provide ad content (e.g. creatives) to one or more of ad network A 104 and ad network N 106. Each of publisher A 108 and publisher N 110 may comprise one or more content servers, which may include a search engine provider such as Yahoo! Search. Ad network A 104 comprises ad server A 120 and ad content server A 122, although Ad network A 104 may comprise more ad servers and ad content servers. Ad network N 106 comprises ad server N 124 and ad content server N 126, although ad network N 106 may comprise more ad servers and ad content servers.

Advertisers may be both legitimate and illegitimate malvertisers who provide, respectively, legitimate and malicious creatives. Communications through network 102 between advertiser A 116 or advertiser N 118 and ad network A 104 or ad network N 106 may include ad creatives to be served to an audience (e.g. end-user A 112 and end-user N 114). Communications through network 102 between publisher A 108 or publisher N 110 and browser A 112 or browser N 114 may include requests for content, responsive content (e.g. in the form of Webpages), requests for ads, responsive ad tags, ad creatives, redirection to third party ad servers, etc. For example, in response to a request for content from browser A 112, publisher A 108 may provide a webpage with one or more ads. Communications through network 102 between ad network A 104 or Ad network N 106 and any one of publisher A 108, publisher N 110, browser A 112 or browser N 114 may include requests for ads, responsive ad tags, ad creatives, redirection to other ad servers, etc. Specifically, ad server A 120 and ad server N 124 may select ads and provide ad tags while content server A 122 and content server N 126 may serve ad content corresponding to ad tags provided to them.

There are nearly infinite possibilities for redirected and/or delegated ad calls and creative content sourcing, which makes it difficult to find, test, detect and prevent malvertisements before they cause substantial harm. For example, a call for an ad to ad server A 112 does not necessarily mean that ad server A 112 will provide the ad. Instead, ad server A 112 may redirect or delegate ad selection to ad server N 116 and so on. Dynamically changing and unpredictable ad creative sourcing and serving poses a daunting task when it comes to finding, testing, discovering and preventing the dissemination and publication of malvertisements before they cause substantial harm.

While publisher level ad security such as Yahoo!'s AdSafe, Google's Caja and Facebook FBJS help protect end-users, not every publisher engages in ad security, which leaves end-users vulnerable. While end-user security such as ad blockers avoids the issue of malvertising, it also defeats the incentive to publish and may make publications inaccessible to end-users.

Thus, systems, methods, and computer program products are needed that address one or more of the aforementioned difficulties in detecting, disabling and/or preventing malvertising.

### BRIEF SUMMARY OF THE INVENTION

Various approaches are described herein for, among other things, an AdVM (Advertising Virtual Machine) system, modules, components and methods that provide multiple layers of ad security for end-users. AdVM is a combination of ad security measures that can be implemented by one or more of advertisers, ad networks, publishers and end-users (audience). AdVM browsers may isolate, monitor and restrict ads in sandboxes. AdVM browsers are configurable to monitor, report abuse and restrict ad performance based on configurable parameters such as system usage, security, privacy, inadvertent clicks, required ad ratings, permissions (whitelisting) and denials (blacklisting). Publishers assist AdVM browsers with ad detection by declaring ad zones in their content (e.g. Webpages), which helps AdVM browsers more easily identify ad creatives to monitor, isolate and/or limit them. AdVM browser abuse reports are used, along with reports from ad testers, to generate published profiles, whitelists and blacklists for advertisers, ads and other advertising participants. An additional layer of ad security may be implemented by configuring AdVM browsers to allow or deny ad performances based on published profiles, whitelists and blacklists. Ad security is improved by participation of advertisers, ad networks and an ad quality authority in evaluating and rating advertisers and/or specific ad creatives against content and quality parameters to create trusted or rated ads that can be selected and verified over untrusted or unrated ads. Advertiser ratings may be securely affixed to ad creatives by digital certificates to prevent tampering or substitution and to increase the level of trust. An additional layer of ad security may be implemented by configuring AdVM browsers, ad networks or publishers to select trusted or rated ads, rank ads and filter out or reject unqualified advertisers and/or specific ad creatives. The multiple layers of ad security may benefit both AdVM and non-AdVM end-users. Improving end-user trust in advertising protects end-users and the economic interests of online participants.

An exemplary method is described for providing advertisement (ad) security implemented by an AdVM content browser application or an ad security module, such as a plug-in or extension of the browser, running on a computer. The AdVM browser requests and receives from a publisher, such as a Website, content along with an ad or an ad call, which the AdVM browser detects. A publisher may provide content with ad tags to help the AdVM browser detect ads and ad calls in the content. A publisher may provide the ad in a sandbox. If the ad is not already in a sandbox or if the sandbox is not configurable by the AdVM browser then the AdVM browser places the ad in a configurable sandbox to create a sandboxed ad. Placing the ad in a sandbox may comprise wrapping the ad in a configurable JavaScript function. The AdVM browser performs the ad in the sandbox. The sandbox may have a default configuration, recommended configuration or a custom configuration provided by an end-user using the AdVM browser. The sandbox may be configured to restrict performance of the ad (e.g. restrict access by the ad to cookies, a document object model (DOM), bandwidth, a processor, a memory), to prevent inadvertent clicking of or other events associated with the ad, to require or verify the ad to be a trusted ad (e.g. whitelisted or digitally signed by a trust authority), to require the trusted ad to have at least one of a minimum, maximum and specific content or quality rating, to monitor ad performance including malicious or abusive indicators or activity (e.g. domain, IP address, invisible iFrames, code that analyzes user environment, use of JavaScript eval function), to automatically report abuse or violation of configuration parameters. Reports may be made to an AdVM database that receives reports of abusive performance of a plurality of ads from a plurality of AdVM browsers. The AdVM browser may access a blacklist or a whitelist of at least one of ads, advertisers and domains maintained in the AdVM database by an AdVM profiler, compare the ad to the blacklist or whitelist; and use the blacklist or whitelist to, respectively, deny or allow performance of the ad based on the comparison.

An exemplary AdVM system is described for providing advertising security to end-users. Exemplary AdVM system participants may comprise, but are not limited to, an AdVM content browser (e.g. audience computer operated by end-user), an AdVM publisher, an AdVM ad network, an AdVM tester, an AdVM profiler, an AdVM database and an AdVM ad quality certificate authority (AQCA). Existing non-AdVM participants may participate in an AdVM system and benefit from it because of the multi-faceted or multi-layered approach to ad security provided by AdVM.

Each of a plurality of AdVM browser applications or ad security modules, such as plug-ins or extensions of browsers, running on computers may provide ad security by sandboxing ads during ad performance, i.e., during runtime. Depending on the implementation, a sandbox may be a type of virtual machine or isolated runtime environment with only authorized external interactions. A sandbox may be created when an AdVM browser detects an ad in content. A sandbox may be created by wrapping detected ad code in a configurable JavaScript function before executing it. Each sandbox may be configured independently or in common for purposes of monitoring for abuse indicators, reporting abuse and restricting ad performance AdVM browsers may actively or passively monitor ad performance, where passive monitoring is akin to logging data and perhaps inquiring about manual intervention based on the data while active monitoring is akin to automated use of data to take automated action, such as restrict performance based on rule violations. AdVM browsers may report abuse or violations, which reports are used to generate recommendations, such as whitelists or blacklists. AdVM browsers may request or otherwise receive the recommendations for use in automatically or manually configuring ad security in AdVM browsers. Such recommendations may be used to accept or reject ads. AdVM browsers may also be configured to require trusted and/or rated ads. Such configuration may be used to modify ad calls or to make decisions whether to permit or deny ad performance. These multiple layers of ad security may be fixed or configurable.

An AdVM publisher may provide ad security or assist with the provision of ad security by other AdVM participants. An AdVM publisher may declare an ad zone in content to assist an audience computer (e.g. content browser) in detecting and sandboxing one or more ads served with content. For example, an HTML Webpage may have an extension called “ad” so that when an AdVM browser observes an “ad” tag a virtual machine is invoked that only permits restricted behavior according to rules. A failure to follow rule of the virtual machine results in a failure to perform the ad. Also, An AdVM publisher may request a trusted or rated ad or reject an untrusted or insufficiently rated ad to be provided with the content. An AdVM publisher may verify an ad to be provided with the content is a trusted ad, such as by verifying a digital signature of ad creative content provided by an AdVM AQCA. An AdVM publisher may also place an ad in a sandbox before serving it (whether alone or embedded in content) to an AdVM or non-AdVM content browser.

An AdVM network may be configured to receive trusted and/or rated ads from an AdVM AQCA as well as untrusted and unrated ads from advertisers. An AdVM ad network may be configured to differentiate between and select among trusted and untrusted ads and/or rated and unrated ads in response to an ad call from an AdVM publisher or AdVM content browser that specifies at least one of a trusted ad and an ad rating level.

An AdVM testing computer or AdVM tester may randomly or periodically interact with ad networks or publishers to investigate ads and advertisers, often in response to ad submission prior to ad runtime. An AdVM tester may emulate a an AdVM browser sandbox during ad performance testing, including randomization using proxies to avoid detection by malvertisements. An AdVM tester may be scaled to simultaneously test many advertisements. An AdVM tester may monitor ad performance relative to rules, check ads for viruses, lookup the age or other history of ad domains, etc. An AdVM tester may profile or report ads and advertisements to an AdVM database.

An AdVM profiler may interact with an AdVM database to compile and analyze a plurality of reports about an ad or advertiser and make recommendations, such as blacklists and whitelists.

An AdVM database may receive, store and transmit reports of abusive performance of a plurality of ads from AdVM testers and AdVM browsers as well as receive, store and transmit recommendations provided by AdVM profilers.

An AdVM AQCA may receive ads from advertisers, ad networks or other participants and may qualify the ads according to levels of trust and/or ratings levels, such as for ad quality and ad content ratings, in accordance with parameters specified by AQCA or another authority.

An exemplary AdVM ad security module is described for providing ad security in a content browser. An AdVM module may be stored, for example, on a computer readable medium comprising computer-executable instructions that, when executed by an audience computer, provide ad security. The AdVM module may permit an end-user to configure the module for purposes of monitoring, reporting and restricting ads and/or ad performance. The AdVM module may detect an ad or a call for an ad in publisher content. The AdVM module may sandbox the ad so that the ad is performed in the sandbox. The AdVM module may monitor performance of the ad, report performance violations and/or restrict performance of the sandboxed ad according to a default or custom configuration of the AdVM module.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies. Unless expressly declared otherwise, each figure represents a different embodiment and components in each embodiment are intentionally numbered differently compared to potentially similar components in other embodiments.

FIG. 1 is a block diagram of a prior art advertising system.

FIG. 2 is a block diagram of an example implementation of an AdVM system in accordance with embodiments described herein.

FIG. 3 is a block diagram of an example implementation of an AdVM browser or security module shown in FIG. 2 in accordance with embodiments described herein.

FIG. 4 is a flowchart of an example method of AdVM browser or security module operation in accordance with embodiments described herein.

FIG. 5 is a flowchart of an example method of configuring an ADVM browser in accordance with embodiments described herein.

FIG. 6 is a flowchart of an example method of submitting ads for trust or rating certification in accordance with embodiments described herein.

FIG. 7 is a flowchart of an example method of creating trusted or rated ads in accordance with embodiments described herein.

FIG. 8 is a flowchart of an example method of requiring trusted or rated ads in accordance with embodiments described herein.

FIG. 9 is a flowchart of an example method of selecting trusted or rated ads in accordance with embodiments described herein.

FIG. 10 is a flowchart of an example method of profiling ads in accordance with embodiments described herein.

FIG. 11 is a block diagram of an example computer system in accordance with an embodiment described herein.

FIG. 12 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments provide, among other things, an AdVM (Advertising Virtual Machine) system, modules, components and methods that provide multiple layers of ad security for end-users. AdVM is a combination of ad security measures that can be implemented by one or more of advertisers, ad networks, publishers and end-users (audience). AdVM browsers may isolate, monitor and restrict ads in sandboxes. AdVM browsers are configurable to monitor, report abuse and restrict ad performance based on configurable parameters such as system usage, security, privacy, inadvertent clicks, required ad ratings, permissions (whitelisting) and denials (blacklisting). Publishers assist AdVM browsers with ad detection by declaring ad zones in their content (e.g. Webpages), which helps AdVM browsers more easily identify ad creatives to monitor, isolate and/or limit them. AdVM browser abuse reports are used, along with reports from ad testers, to generate published profiles, whitelists and blacklists for advertisers, ads and other advertising participants. An additional layer of ad security may be implemented by configuring AdVM browsers to allow or deny ad performances based on published profiles, whitelists and blacklists. Ad security is improved by participation of advertisers, ad networks and an ad quality authority in evaluating and rating advertisers and/or specific ad creatives against content and quality parameters to create trusted or rated ads that can be selected and verified over untrusted or unrated ads. Advertiser ratings may be securely affixed to ad creatives by digital certificates to prevent tampering or substitution and to increase the level of trust. An additional layer of ad security may be implemented by configuring AdVM browsers, ad networks or publishers to select trusted or rated ads, rank ads and filter out or reject unqualified advertisers and/or specific ad creatives. The multiple layers of ad security may benefit both AdVM and non-AdVM end-users. Improving end-user trust in advertising protects end-users and the economic interests of online participants.

### II. Example Embodiments

As used herein, content is any content provided by any source, including search results provided by a search engine. Content may include web pages, images, videos, other types of files, output of executables, etc. and/or links thereto. Each web page, image, video, etc. is referred to as content or as a content element.

As used herein, a content browser is any computing device and/or process executing thereon that accesses and provides content (e.g. by sight, touch, sound or computer readable method) to a content consumer. A content consumer may be human or a machine.

As used herein, a content provider is any computer accessible source of content. As used herein, a publisher is any computer accessible source of content accessible by a content consumer, e.g. using a content browser. Servers and web sites (e.g. blog, retailer, news publication, search engine) are examples of content providers and publishers. Thus, a web site providing a computer accessible search engine and search results, such as Yahoo! Search, is both a content provider and publisher.

As used herein, a sandbox is a security mechanism that isolates code executed by a computing device during runtime. A virtual machine is one example of a sandbox.

As used herein, abuse is intentional, unintentional, unethical or malicious misleading of an end-user or publisher or misuse or excessive use of a computing device resource. As used herein, malicious is intentionally abusive.

As used herein, a trusted item (e.g. ad) is an item that has been against specific criteria and passed. There may be different levels of trust based on different parameters for criteria or different criteria. There may be different sets of criteria for different topics such as content and quality.

As used herein, rating is evaluating and scoring an item (e.g. ad) against specific criteria.

As used herein, performance of an ad is execution of code affiliated with the ad.

As used herein, and/or, e.g., as in A and/or B, is simple logic where A, B and A and B each satisfy the statement.

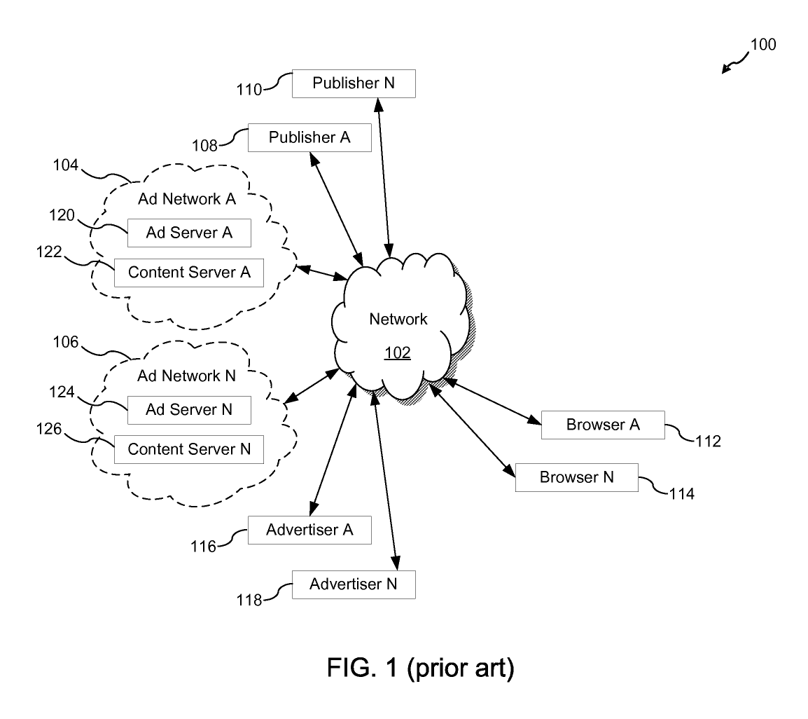

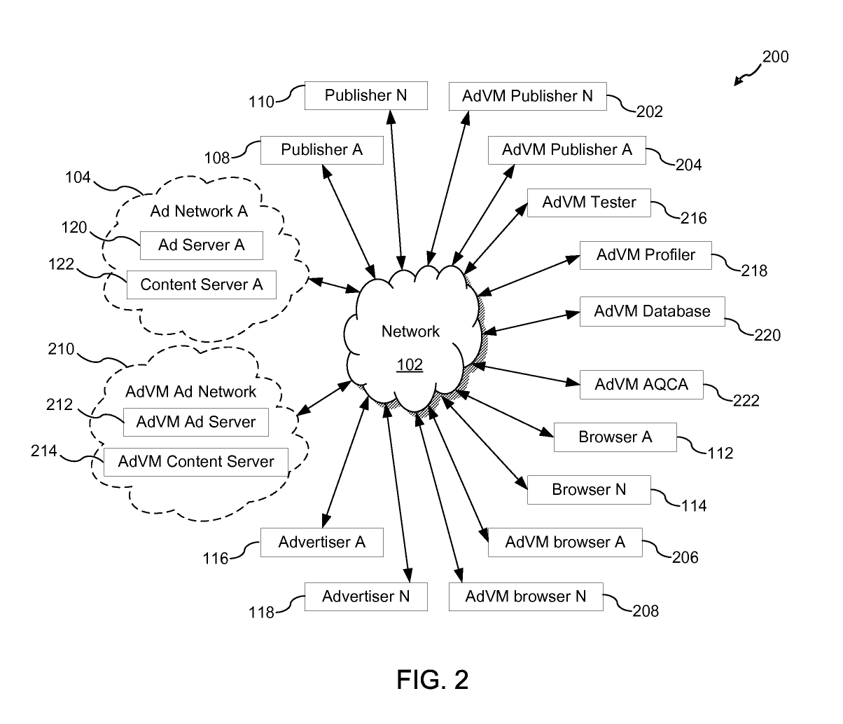

FIG. 2 is a block diagram of an example implementation of an AdVM system in accordance with embodiments described herein. AdVM system 200 comprises multiple participants, including ad networks, publishers, advertisers and end-users using browsers communicatively coupled to network 102 (e.g. Internet). There may be many more advertising networks, publishers, advertisers and end-users than shown in FIG. 2. As shown in FIG. 2, an embodiment of an AdVM system 200 may comprise, but is not limited to, prior art ad system participants shown in FIG. 1 as well as AdVM system participants AdVM publisher A 202, AdVM publisher N 204, AdVM browser A 206, AdVM browser N 208, AdVM network 210, AdVM ad server 212, AdVM content server 214, AdVM tester 216, AdVM profiler 218, AdVM database 220 and AdVM ad quality certificate authority (AQCA) 222. AdVM browser A 206 and AdVM browser N 208 are collectively referred to as AdVM browsers A-N 206-208, where N may be an infinite number. AdVM publisher A 202 and AdVM publisher N 204 are collectively referred to as AdVM publishers A-N 202-204, where N may be an infinite number. The number and type of each of the participants in embodiments of AdVM system 200 may vary between embodiments, which means that in some embodiments some of the participants shown in FIG. 2 may not exist and in other embodiments additional participants may exist. It can be seen by comparison to FIG. 1 that prior art participants may coexist with and even benefit from AdVM participants. AdVM system 200 may provide advertising security to ADVM end-users and/or publishers as well as pre-existing end-users and/or publishers.

Each of AdVM browsers A-N 206-208 may comprise, for example, a content browsing application (i.e. browser) executing on a computing device operated by an end-user (not shown) with an ADVM module (e.g. ad security module) integrated into the browser or implemented as an extension or plug-in of the browser. AdVM browsers A-N 206-208 may, for example, comprise a modified version of known browsers such as Mozilla Firefox™ and Microsoft Internet Explorer™. Each of AdVM browsers A-N 206-208 may provide ad security by sandboxing ads during ad performance, i.e., during runtime. Depending on the implementation, a sandbox may be a type of virtual machine or isolated runtime environment with only authorized external interactions. A sandbox may be created when one of AdVM browsers A-N 206-208 detects an ad in content. A sandbox may be created by wrapping detected ad code in a configurable JavaScript function before executing it. Each sandbox may be configured independently or in common for purposes of monitoring for abuse indicators, reporting abuse and restricting ad performance. AdVM browsers A-N 206-208 may actively or passively monitor ad performance, where passive monitoring is akin to logging data and perhaps inquiring about manual intervention based on the data while active monitoring is akin to automated use of data to take automated action, such as to restrict performance based on rule violations. Active monitoring, e.g., monitoring for abuse indicators, is integrated with rule enforcement, as in a firewall. AdVM browsers A-N 206-208 may report abuse or violations, which reports are used to generate recommendations, such as whitelists or blacklists. AdVM browsers A-N 206-208 may request or otherwise receive the recommendations for use in automatically or manually configuring ad security in AdVM browsers A-N 206-208. Such recommendations may be used to accept or reject ads. AdVM browsers A-N 206-208 may also be configured to require trusted and/or rated ads. Such configuration may be used to modify ad calls or to make decisions whether to permit or deny ad performance. AdVM browsers A-N 206-208 may verify ads are trusted ads, such as by verifying a digital signature of ad creative content provided by AdVM AQCA 222. Each of these multiple layers of ad security may be enabled or disabled or may be fixed.

AdVM publishers A-N 202-204 provide content and ads or ad calls to AdVM browsers A-N 206-208 and browsers A-N 112-114. Additionally, each of AdVM publishers A-N 202-204 may provide ad security or assist with the provision of ad security by other AdVM participants. Each AdVM publisher A-N 202-204 may declare an ad zone in content to assist AdVM browsers A-N 206-208 in detecting and sandboxing one or more ads served with content. For example, an HTML Webpage may have an extension called “ad” so that when one of AdVM publishers A-N 202-204 observes an “ad” tag a virtual machine is invoked that only permits restricted behavior according to rules. A failure to follow a rule of the virtual machine may result in a refusal to perform the ad. Also, AdVM publishers A-N 202-204 may request a trusted or rated ad or reject an untrusted or insufficiently rated ad to be provided with content to AdVM browsers A-N 206-208 and browsers A-N 112-114. AdVM publishers A-N 202-204 may verify ads to be provided with content are trusted ads, such as by verifying a digital signature of ad creative content provided by AdVM AQCA 222. AdVM publishers A-N 202-204 may also place one or more ads in a sandbox before serving it (whether alone or embedded in content) to AdVM browsers A-N 206-208 and browsers A-N 112-114.

AdVM ad network 210 comprises AdVM ad server 212 and AdVM content server 214, although AdVM network 210 may comprise more AdVM and non-AdVM ad servers and ad content servers. AdVM ad server 212 may select and serve ads and AdVM content server 214 may serve content (e.g. creative) for selected ads. AdVM ad network 210 may be configured to receive trusted and/or rated ads as well as untrusted and unrated ads. An AdVM ad network 210 may be configured to receive, store, rank, differentiate between, select among and serve trusted and untrusted ads and rated and unrated ads, e.g., in response to an ad call from AdVM publishers A-N 202-204 or AdVM browsers A-N 206-208 that specifies at least one of a trusted ad and an ad rating level.

AdVM tester 216 tests ads. AdVM tester 216 may randomly or periodically interact with and receive information from AdVM database 220, AdVM profiler 218, ad network A 104, AdVM ad network 210, publishers A-N 108-110 and/or AdVM publishers A-N 202-204 to investigate ads and advertisers, often in response to ad submission prior to ad runtime. AdVM tester 216 may be scaled to simultaneously test many advertisements. AdVM tester 216 may be configured to emulate one or more AdVM browser sandboxes to simultaneously test the performance of ad creatives and report results to AdVM database 220 for analysis and recommendation by AdVM profiler 218. AdVM tester 216 may implement randomization using proxies to avoid detection by malvertisements. AdVM tester 216 may monitor ad performance relative to rules, check ads for viruses, lookup the age or other history of ad domains and perform other tests to determine whether ads are suspicious, high-risk, abusive or malicious.

AdVM profiler 218 profiles, ad, advertisers and other ad participants based on reports generated by AdVM tester 216 and AdVM browsers A-N 206-208. AdVM profiler 218 may interact with AdVM database 220 to compile and analyze a plurality of reports about an ad or advertiser and make recommendations, such as blacklists and whitelists, for use by AdVM browsers A-N 206-208. FIG. 10 is a flowchart of an example method 1000 of profiling ads in accordance with embodiments described herein. In step 1002, AdVM profiler 218 accesses AdVM database 220 for ad reports from AdVM tester 216 and AdVM browsers A-N 206-208. Ad reports may comprise any to all ad reports about pre-performance, performance, security levels 1, 2 or 3 that pertain to ads. AdVM profiler 218 may also access ad trust and rating evaluation reports generated by AdVM AQCA 222. The various reports may pertain to one or more of ads, advertisers, ad networks and/or other ad participants. In step 1004, AdVM profiler 218 analyzes all reports pertaining to an ad. AdVM profiler may concurrently analyze reports for a plurality of ads. In step 1006, AdVM profiler 218 generates recommendations, based on the analyses of reports, about ads, advertisers, ad networks and/or other ad participants. Such recommendations may be in the form of whitelists recommending and blacklists recommending against ads, advertisers, ad networks and/or other ad participants. In step 1008, AdVM profiler 218 publishes recommendations, e.g., to AdVM database 220. Recommendations may be published publicly, only to AdVM participants, or to specific AdVM participants. In some embodiments, recommendations may be used by any participant in making automated or manual decisions pertaining to ad participants.

AdVM database 220 manages ad reports and ad profiles. AdVM database 220 may have data management and user interface, e.g., search, components (not shown). AdVM database 220 may receive, store, manage and provide (i.e. publish) reports of abusive performance of a plurality of ads from AdVM tester 216 and AdVM browsers A-N 206-208 as well as receive, store and provide recommendations provided by AdVM profiler 218. AdVM database 220 may also receive, store and provide certificates provided by AdVM AQCA 222. AdVM database 220 may be centralized or distributed, which may mean that AdVM system 200 participants communicate with the same or different instantiations of AdVM database 220. For example, each AdVM participant may have its own decentralized storage mechanism. While AdVM participants may access AdVM database 220, AdVM database 220 may comprise or be associated with an alert module (not shown), e.g., to broadcast important alerts to AdVM participants. AdVM participants may respond by automatically adding a rule or users may manually add a rule for passive or active monitoring based on information in the alert. Such an alert system would help prevent spreading a malicious ad between the time that AdVM browsers are configured to periodically download updates from AdVM database 220.

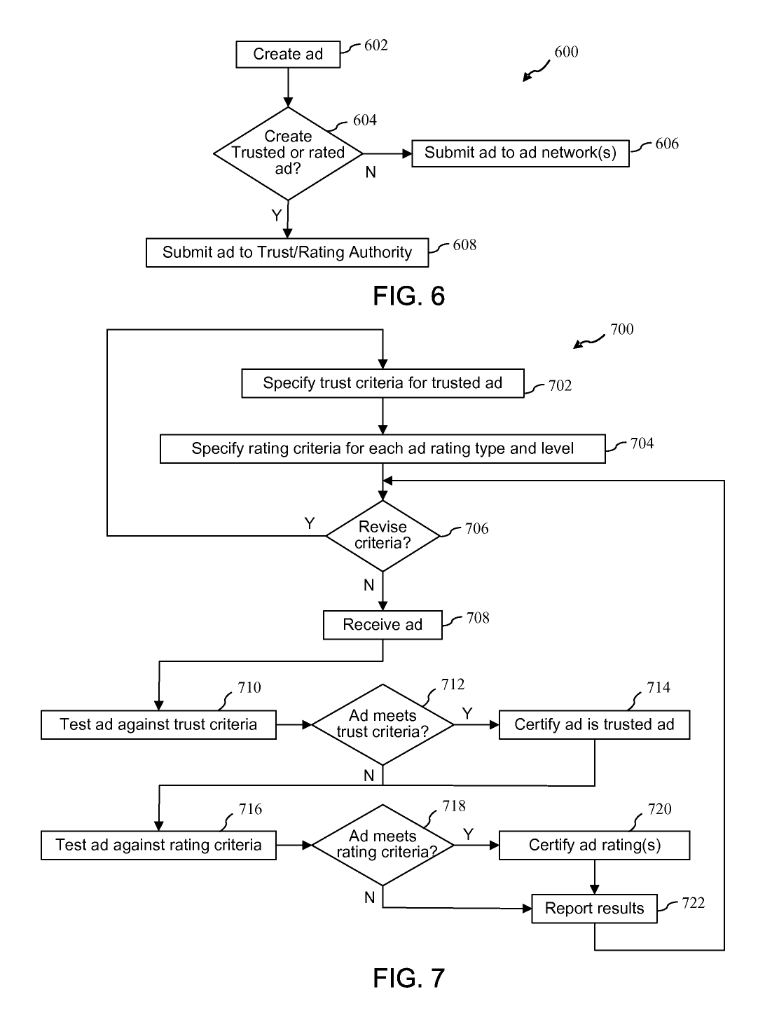

AdVM AQCA 222 evaluates, certifies or denies certification of ads as trusted and/or rated ads. AdVM AQCA 222 may receive ads from advertisers A-N 116-118, ad network A 104, AdVM network 210 or other participants. For example, FIG. 6 is a flowchart of an example method 600 of submitting ads for trust or rating certification in accordance with embodiments described herein. In step 602, one of advertisers A-N 116-118, or a third party acting on behalf of one of advertisers A-N 116-118, may create an ad, e.g., create ad content. In step 604, an advertiser chooses whether to submit the ad to AdVM AQCA 222 for trust and/or rating analysis. If no in step 604, then in step 606 the ad is submitted to one of ad network A 104, ad network N 106, AdVM network 210, etc. If yes in step 604, then in step 608 the ad is submitted to a trust/rating authority such as, but not limited to, AdVM AQCA 222.

AdVM AQCA may evaluate and qualify ads according to levels of trust and/or ratings levels, such as for ad quality ratings and ad content ratings, in accordance with criteria and parameters for each trust and rating type and level specified by AQCA or another authority. There may be different levels of trust based on different parameters for criteria or different criteria. There may be different sets of criteria for different topics or types, such as content and quality. In some embodiments, certification may comprise digitally signing trust and/or rating certificates. The authenticity of a certificate may be verified by AdVM network 210, AdVM publishers A-N 202-204 and/or AdVM browsers A-N 112-114. Certification and verification may be implemented by known methods. In one embodiment, AdVM AQCA 222 may include verification infrastructure accessible by one or more of AdVM network 210, AdVM publishers A-N 202-204 and AdVM browsers A-N 112-114 to verify the authenticity of trust and/or rating certificates associated with ads. In one embodiment, whitelisted publishers such as Yahoo! and Google may have their own ad certification, perhaps in addition to other certification authorities. AdVM participants may configure to accept or reject certificates from one or more certifying authorities.

FIG. 7 is a flowchart of an example method 700 of creating trusted or rated ads in accordance with embodiments described herein. In step 702, AdVM AQCA 222 or other authority specifies trust criteria for trusted ads. For example, trust criteria may comprise a positive experience history with a particular advertiser or ad creator submitting an ad, their participation or membership in an ad ethics organization, evaluation and passage of ads over a minimum rating level or a minimum set of abuse parameters, etc. There may be multiple levels of trust, each with their own set of criteria advertisers must comply with to receive a certificate for a particular level. In step 702, AdVM AQCA 222 or other authority specifies rating criteria for each ad rating type and level. For example, types of ratings may comprise, but are not limited to, ad quality and ad content. Each type may have a plurality of levels. Criteria may be specified for each type and each level of rating. Criteria for ad quality ratings may comprise, for example, criteria that AdVM browser users may monitor or restrict, e.g. use of JavaScript eval functions or other string manipulations and code obfuscations, access to blacklisted ads, IP addresses or domains, invisible iFrames, code that analyzes user environment, inadvertent clicking on ads or other events used by the ad, access to cookies, access to a document object model (DOM), CPU usage, network bandwidth usage and memory usage. Different criteria and/or parameters for each criteria may be set for each level. Minimum levels, maximum levels, ranges and pass/fail standards (parameters) may be set for each criteria in each level. Different criteria and/or parameters for each criteria may be set for each level. Minimum levels, maximum levels, ranges and pass/fail standards (parameters) may be set for each criteria in each level.

In step 706, criteria and parameters for criteria may be revised. If criteria is to be revised, method 700 returns to step 702. If criteria is not to be revised then method 700 waits to receive an ad for evaluation. In step 708 an ad is received. In some embodiments, ads may be received with instructions or parameters specifying what an ad is to be evaluated for. In step 710, the ad is tested against trust criteria. Again, there may be multiple levels of trust, each with its own criteria and parameters to evaluate for the ad. In step 712, a decision is made whether the ad meets trust criteria. For example, if there are multiple levels of trust, the decision may be for the highest level for which the ad qualifies. If the ad meets trust criteria then in step 714 the ad is certified as a trusted ad. The certification may be for multiple levels or the highest level of trust for which the ad satisfied trust criteria. Certification may comprise one or more security measures, such as a digital signature, that can be verified to ensure certified ads are legitimate and have not been tampered with. Known security measures may be implemented for this purpose. According to method 700, regardless whether the ad meets trust criteria or not, steps 712 and 714 lead to step 716 where the ad is tested against rating criteria. Again, there may be multiple rating levels, each with its own criteria and parameters to evaluate for the ad. In step 718, a decision is made whether the ad meets rating criteria. For example, if there are multiple rating levels, the decision may be for the highest level for which the ad qualifies. If the ad meets rating criteria then in step 720 the ad is certified as a rated ad. The certification may be for multiple levels or the highest rating level for which the ad satisfied rating criteria. Certification may comprise one or more security measures, such as a digital signature, that can be verified to ensure certified ads are legitimate and have not been tampered with. Known security measures may be implemented for this purpose. According to method 700, regardless whether the ad meets rating criteria or not, steps 718 and 720 lead to step 722 where results are reported, e.g., to the advertiser or other party submitting the ad, to a database used by AdVM AQCA 222, to AdVM database 220. Method 700 finally returns to step 706.

Each participant illustrated in FIG. 2 as well as participants not illustrated in FIG. 2 may communicate with other participants through network 102. There may be an AdVM communication protocol for specific and general types of communication between AdVM participants. For example, communications through network 102 between advertisers A-N 116-118 and ad network A 104 or AdVM ad network 210 may include ad tags and/or ad creatives to be served to an audience (e.g. one or more of browsers A-N 112-114 and AdVM browsers A-N 206-208). Ad creative may include trusted or rated ads and trusted or rated ad certificates. Communications may include ad campaign instructions, e.g., target audience, dates, times to present ads to consumers.

Communications through network 102 between each of advertisers A-N 116-118 and AdVM AQCA 222 may include ad content necessary for evaluation relative to trusted and/or rated ad criteria and parameters. The communication may include instructions whether to evaluate ad content for general or specific trust criteria and/or rating criteria. Following evaluation, AdVM AQCA 222 may communicate to respective advertisers A-N 116-118 evaluation results, a digitally signed trust and/or rating certificate(s) for the ad content. Trust and/or rating certificates may also be provided to other participants of AdVM system 200. AdVM AQCA 222 may maintain signed certificates for purposes of verification upon request from AdVM ad network 210, AdVM publishers A-N 202-204, AdVM browsers A-N 206-208 or other AdVM system 200 participants. Thus, AdVM AQCA 222 or a trusted third party may communicate with one or more of AdVM ad network 210, AdVM publishers A-N 202-204, AdVM browsers A-N 206-208 for purposes of verifying the authenticity of trust and/or rating certificates associated with ads. AdVM AQCA 222 may also communicate with AdVM database 220, AdVM profiler 218 and/or AdVM tester 216 for information during an initial or subsequent evaluation of an ad.

Communications through network 102 between AdVM database 220 and other AdVM system 200 participants may be numerous. AdVM database 220 may store, manage and publish ad test reports provided by AdVM tester 216, ad performance reports provided by AdVM browsers A-N 206-208, ad recommendations (e.g. whitelists, blacklists) provided by AdVM profiler 218, ad trust and rating certificates provided by AdVM AQCA 222, etc. All participants may have one or more reasons to communicate with AdVM database 220 in order to send information, search information or receive information stored, managed or published by AdVM database. An integrated or associated alert module (not shown) may also communicate with AdVM participants to communicate important alerts.

Communications through network 102 between ad network A 104 or AdVM ad network 210 and any of publishers A-N 108-110 or AdVM publishers A-N 202-204 may comprise making arrangements for publishers (e.g. websites) to provide ads with content. Publishers A-N 108-110 or AdVM publishers A-N 202-204 may embed ads or ad calls in their content (e.g. Webpages). Such ads and/or ad calls may be for particular or dynamically selected ads, which may be selected based on information about end-users. AdVM publishers A-N 202-204 may send ad calls to AdVM network 210 in response to requests for content from AdVM browsers A-N 206-208 or browsers A-N 112-114. AdVM network 210 would respond to such an ad call by selecting and providing one or more ads. AdVM publishers A-N 202-204 may communicate a request or requirement for trusted or rated ads to AdVM ad network 210. The request or requirement may be in the form of a modified ad call with parameters specifying particular trust or rating level(s).

AdVM browsers A-N 206-208 may access participants of AdVM system 200 such as, but not limited to, AdVM publishers A-N 202-204, publishers A-N 108-110, AdVM database 220, ad network A 104 and AdVM ad network 210. AdVM browsers A-N 206-208 may, among other activities, request, download, save, run (i.e. execute) or browse content and ads provided (i.e. published) by participants of AdVM system 200. AdVM browsers A-N 206-208 may communicate with AdVM database 220 to send ad performance reports and to receive recommendations, e.g., ad whitelists and blacklists for use in allowing and denying ad performances.

Communications through network 102 between publishers A-N 108-110 or AdVM publishers A-N 202-204 and browsers A-N 112-114 or AdVM browsers A-N 206-208 may include requests for content, responsive content (e.g. in the form of Webpages, requests for ads), including ad tags to identify one or more ads, responsive ad creative or redirection to third party ad servers, etc. In response, content, ads and/or redirection may be provided to AdVM browsers A-N 206-208 or browsers A-N 112-114. For example, in response to a request for content from browser A 112, publisher A 108 may provide a webpage with one or more ads or ad calls. Each of publishers A-N 108-110 and AdVM publishers A-N 202-204 may serve content without ads, with ads and/or with ad calls. Communications pertaining to ads may lead to communications between browsers A-N 112-114 or AdVM browsers A-N 206-208 and ad network A 104 or AdVM ad network 210 to select and serve an ad in response to an ad call. AdVM ad network 210, AdVM publishers A-N 202-204 and AdVM browsers A-N 206-208 have advanced capabilities that their non-AdVM counterparts do not have. Specifically, AdVM Ad server 212 may manage and select between trusted and non-trusted ads and rated and non-rated ads while AdVM content server 214 may serve corresponding ad content. While, in some embodiments, ad network A 104 may be provided with and serve trusted and rated ads, it would not have the capability of distinguishing between trusted and non-trusted ads and rated and non-rated ads. Further, in some embodiments, AdVM publishers A-N 202-204 and/or AdVM browsers A-N 206-208, in addition to being capable of rejecting unqualified ads, may be capable of requesting trusted and/or rated ads, including modifying ad calls by adding parameters to ad calls that require trusted and/or rated ads, which results in communicating a modified ad call or a new ad call to AdVM ad network 210. Thus, requests for ads from AdVM browsers A-N 206-208 to one of AdVM publishers A-N 202-204 and AdVM ad network 210 may specify parameters for a trusted and/or rated ad. Responsive to such an ad call, AdVM ad network 210 may select and communicate ad creative(s) satisfying the ad call.

FIG. 9 is a flowchart of an example method 900 of selecting trusted or rated ads in accordance with embodiments described herein. In step 902, AdVM ad network 210 receives an ad call, e.g., from one of AdVM publishers A-N 202-204 or one of AdVM browsers A-N 206-208. In step 904 a decision is made whether the ad call comprises trusted or rated ad parameters. If the ad call does not comprise one or more trusted or rated ad parameters then in step 908 AdVM ad network 210, e.g., AdVM ad server 212, may select an ad from all available ads. If the ad call does comprise one or more trusted or rated ad parameters then in step 906 AdVM ad network 210, e.g., AdVM ad server 212, selects an ad from among ads satisfying the trusted and/or rated ad parameter(s) in the ad call received in step 902.

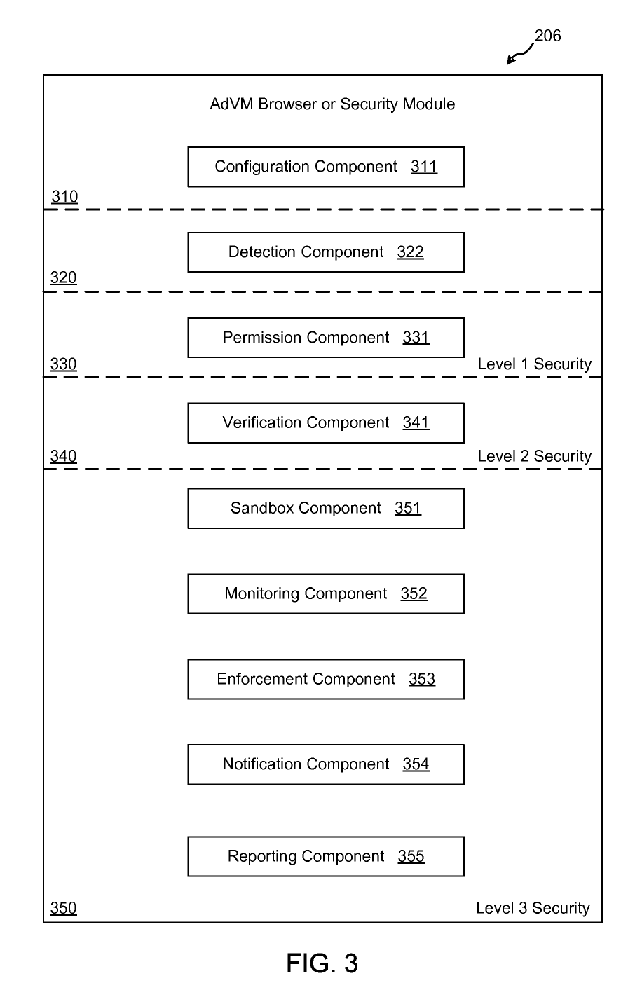

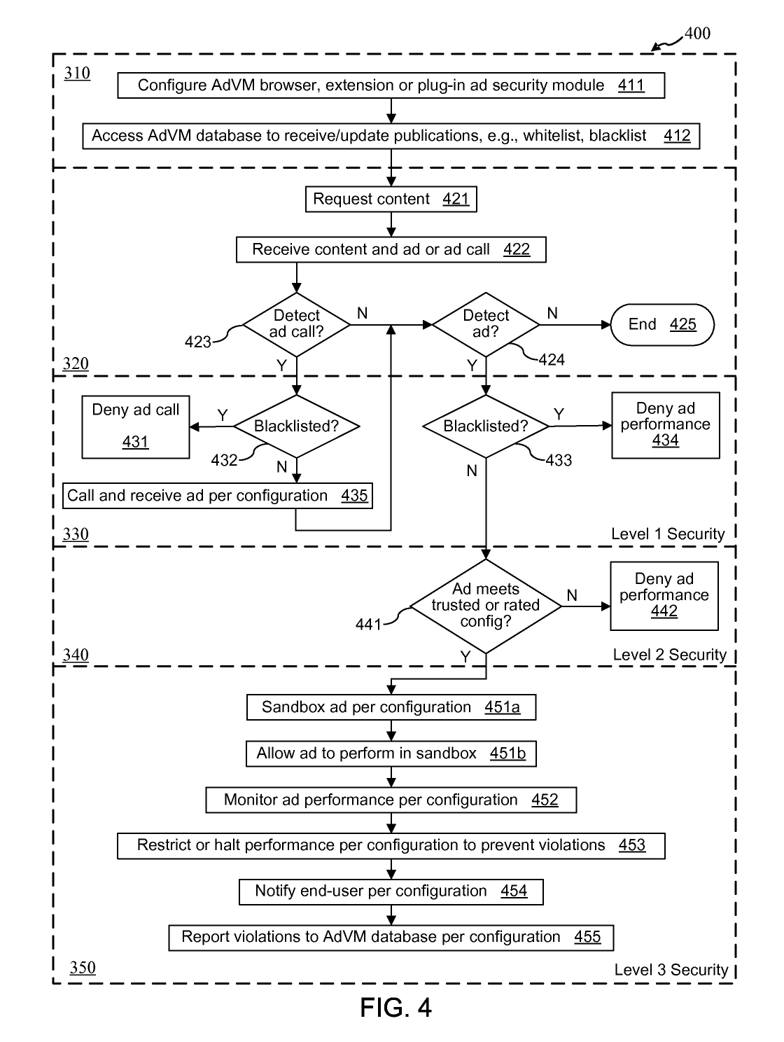

FIGS. 3 and 4 provide detailed embodiments of AdVM browser 206 introduced in FIG. 2. Therefore, FIGS. 3 and 4 are presented together. FIG. 3 is a block diagram of an example implementation of AdVM browser 206 in accordance with embodiments described herein while FIG. 4 is a flowchart of an example method of AdVM browser 206 operation in accordance with embodiments described herein. FIG. 4 provides one exemplary method 400 how modules and components illustrated in FIG. 3 may provide ad security. The steps in method 400 are not restricted to the order shown in method 400. In various embodiments, steps may be implemented in a different order, some steps may not be implemented while additional steps may be implemented. AdVM browser 206 may, of course, comprise AdVM functionality integrated in a browser or an AdVM ad security module such as a browser extension or plug-in for a browser such as browser A 112. In the embodiment shown in FIG. 3, AdVM browser 206 is separated into five functional modules, although more or fewer functional modules may be implemented. AdVM browser 206 comprises a configuration module 310, ad detection module 320, level 1 security module 330, level 2 security module 340 and level 3 security module 350.

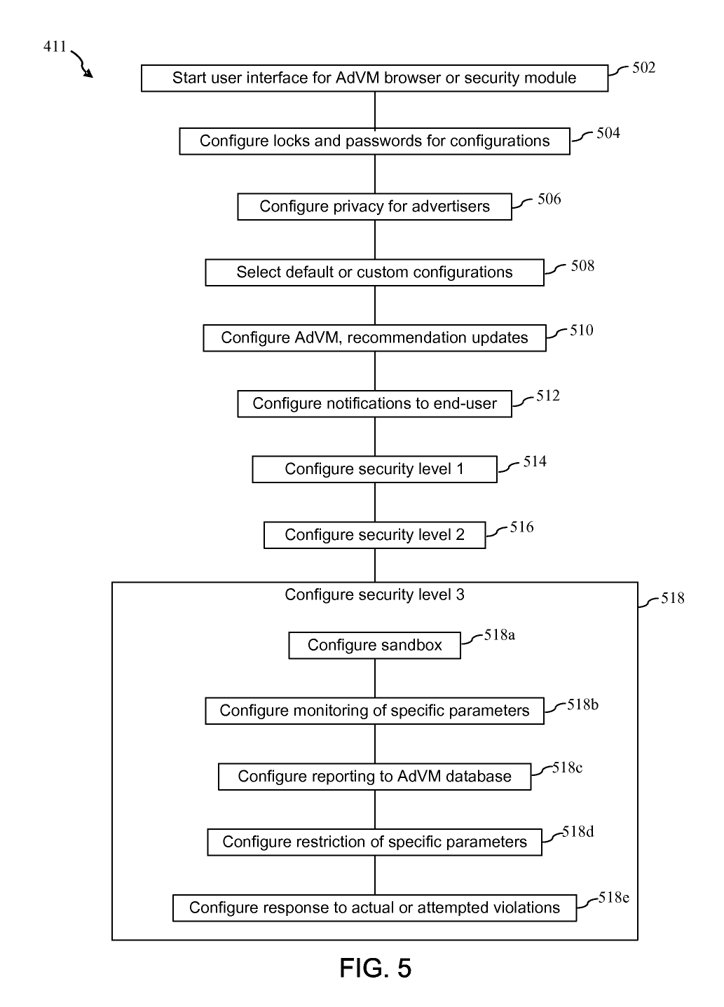

Configuration module 310 comprises configuration component 311. Configuration component 311 may configure any aspect, module or component of AdVM browser 206, including but not limited to, locks and passwords to change the configuration, privacy, default and custom configurations, ad detection, ad permissions and denials based on recommendations, browser updating and downloads (e.g., whitelists, blacklist recommendations), ad trust and rating requirements and verifications, ad performance sandboxing, monitoring, reporting, user-notifications and restrictions, etc. Other modules and components of AdVM browser 206 may implement configuration(s) specified by configuration component 311. One example of some, though not all, steps that may be performed by configuration component 311 is illustrated in FIG. 4. Specifically, step 411 comprises configuring AdVM browser (or an AdVM browser extension or plug-in ad security module for a browser). An exemplary implementation of step 411 is presented in FIG. 5.

FIG. 5 is a flowchart of an example method of configuring an ADVM browser in accordance with embodiments described herein. Configuration step 411 may comprise one or more of steps 502-518 or additional or alternative steps without any particular order. Configuration step 411 may, for example, begin with step 502, starting a user interface for AdVM browser or security module 206. Such a user interface may provide information and an ability to configure AdVM browser 206. In step 504, AdVM browser 206 may be configured for locks and passwords to modify configuration(s). In step 506, end-user privacy may be configured to permit or deny access to various types of information and information gathering techniques implemented by advertisers based on privacy levels or manual configuration of individual privacy items. There may be multiple levels of privacy, each with default and/or custom configurable items, such as what types of cookies will be accepted, what types of data collection are permitted. In some embodiments an end-user may have multiple configurations, e.g., one for whitelisted ads and ad participants, one for unknown ads and ad participants, one for blacklisted or risky ads and ad participants, etc. In step 508, end-users may select among default and custom configurations. In step 510, updates may be configured, e.g., by enabling or disabling updates, setting update times and dates for a variety of updates. For example, there may be updates for AdVM browser 206 and/or information used by AdVM browser 206, such as recommendations determined by AdVM profiler 218 and rating and trust criteria and parameters determined by AdVM AQCA 222. In step 512, notifications to an end-user, such as notifications of blocked ads or other alerts, may be configured. In step 514, security level 1 may be configured. For example, security level 1 may be enabled, disabled, the use of whitelists and/or blacklists may be enabled or disabled, manual entry of whitelisted or blacklisted ads may be made, the reporting of encounters with blacklisted ads to AdVM database 220 may be enabled or disabled, etc. For example, an end-user may configure AdVM browser 206 to do nothing or to send a blacklist report to AdVM database 220. Of course, the available responses may depend on what AdVM database 220 supports.

In step 516, security level 2 may be configured. For example, security level 2 may be enabled or disabled and specific criteria and parameters may be specified for rated and trusted ads. Specific criteria and parameters for rated and trusted ads may be developed and periodically updated by AdVM AQCA 222 or another authority and published on AdVM database 220 for all AdVM participants. In some embodiments, this information may be used by AdVM browser 206 to guide an end-user in making decisions. Thus, AdVM browser 206 may access and download from AdVM database 220 a published list (or layman's summary) of the trust and rating criteria and parameters use by AdVM AQCA 222 to qualify ads for one or more levels of trust and rating categories. During configuration using configuration module 310, an end-user may configure AdVM browser 206 during step 516 to require trusted and/or rated ads, specify specific types of ratings (e.g., content and/or quality), specify particular criteria and parameters for trust and/or one or more types of rating (e.g. at least one of a minimum, maximum and specific content or quality rating) or, alternatively, an end-user may select levels having predefined criteria and parameters. An end-user may configure AdVM browser 206 to deny ad performances for unqualified ads. Step 516 may also enable an end-user to configure a response to encountering ads with expired or inaccurate trust or rating certificates discovered during validation. A user may configure AdVM browser 206 to do nothing or to send a certificate violation report to AdVM database 220. Of course, the available responses may depend on what AdVM database 220 supports.

In step 518, security level 3 may be configured. For example, security level 3 may be enabled or disabled and an end-user may accept or decline default or custom configurations for level 3 components, e.g. sandbox component 351, monitoring component 352, enforcement component 353, notification component 354 and reporting component 355. In step 518a, a sandbox may be configured for ad performances. Sandboxing may be enabled or disabled, particular implementations of sandboxing may be selected such as wrapping ads in JavaScript. In step 518b, monitoring of specific parameters before and during ad performances may be configured. For example, monitoring of abuse indicators in ad code (e.g. existence of JavaScript eval function in ad code, IP addresses, domains, invisible iFrames, code that analyzes user environment, clicking on ads or other events used by the ad), CPU usage, network bandwidth usage, memory usage, network accesses and addresses, access to cookies and other privacy-related information, access to a document object model (DOM). In step 518c, reporting (e.g. to AdVM database 220) may be configured. Reporting may be enabled or disabled, reporting times may be set, e.g., one time per day or at the occurrence of an event, report contents, information disclosure limitations to protect privacy, summary copies of reports may be kept, etc. Report contents may include the abusive ad code. In step 518d, restrictions imposed on ad performances may be configured. Restrictions may be enabled or disabled and restrictions for specific parameters may be configured. For example, parameter restrictions may restrict or prohibit: use of JavaScript eval functions or other string manipulations and code obfuscations, access to blacklisted ads, IP addresses or domains, invisible iFrames, code that analyzes user environment, inadvertent clicking on ads or other events used by the ad, access to cookies, access to a document object model (DOM) and may restrict CPU usage, network bandwidth usage and memory usage. As one example, a rule may be created, monitored and enforced to block all clicks or other events such as hovering on ads or require double clicks or always prompt for confirmation before generating a click or other event for an ad. As another example, a rule may be enforced that an ad cannot use more than 5% of CPU availability at peril of denial or termination of ad performance. Another rule may be enforced that an ad cannot download more than 500 kb (kilobytes) of data at peril of denial or termination of ad performance. Another rule may prohibit downloading ads outside whitelisted ad servers. As a result of restrictions, ad performance may become a rule-based performance where performance is only allowed so long as it does not violate rules. In step 518e, response to actual or attempted violations, e.g., abuse or configured rule violations, may be configured. Responses may be enabled or disabled and specific responses may be configured. For example, a response may be to perform one or more of: sending a report to AdVM database 220, preventing the violation, denying ad performance, terminating ad performance.

Returning to FIG. 4, in step 412 AdVM database 220 is accessed to obtain or update publications such as recommendations (e.g. whitelists, blacklists) for use by level 1 security module 330 and trust and rating criteria and parameters and validation information for use by level 2 security module 340. AdVM browser 206 may operate based on configuration(s) specified in and information downloaded by configuration component 311.

In this embodiment, following configuration using configuration module 310, method 400 proceeds to ad detection module 320. Ad detection module 320 comprises detection component 322. One example of steps that may be performed by detection component 322 is illustrated in FIG. 4. In response to requesting content 421 and receiving content and an ad or ad call 422, ad detection module 320 determines whether there is an ad call or an ad. In step 423, if an ad call is detected then level 1 security may be implemented in level 1 security module 330 before returning to ad detection step 424. If an ad call is permitted, then an ad call may be performed by calling the ad. However, if an ad call is not detected in step 423 then a determination is made in step 424 whether an ad is detected. If an ad is detected then level 1 security may be implemented in level 1 security module 330. Otherwise, if an ad is not detected, then the method of providing ad security 400 for this interaction may end in step 425.

Level 1 security module 330 comprises permission component 331. Permission component 331 may be implemented in response to detection of an ad or ad call by ad detection module 320. Permission component 331 may be configured to rely on recommendations generated by AdVM profiler 218 stored in AdVM database 220. Such recommendations may comprise whitelists and blacklists of ads, advertisers, domains, ad calls, etc. An end-user or AdVM browser 206 may also generate recommendations or requirements. An end-user may configure permission component 331 to rely on one or more of such recommendations or requirements. One example of steps that may be performed by permission component 322 is illustrated in FIG. 4. Upon detection of an ad call in step 423, in step 432 permission component 322 may determine whether the ad call is blacklisted based on a recommendation by AdVM profiler 318 or other recommendation or requirement. If the ad call is blacklisted, then in step 431 the ad call is denied. If the ad call is not blacklisted, in step 435 the ad call may be executed to call and receive the ad according to the configuration of AdVM browser 206. For example, if the configuration requires a trusted or rated ad, then the ad call may be modified by adding parameters specifying an ad trust and/or rating level. The method returns to step 424 to detect receipt of the called ad. Upon detection of the called ad in step 424, in step 433 permission component 322 may determine whether the ad is blacklisted based on a recommendation by AdVM profiler 318 or other recommendation or requirement. If the ad is blacklisted, then in step 434 performance of the ad is denied. If the ad is not blacklisted, method 400 proceeds to level 2 security module 340, which may or may not be implemented depending on the configuration of AdVM browser 206 specified in configuration module 310.

Level 2 security module 340 comprises verification component 341. One example of steps that may be performed by verification component 341 is illustrated in FIG. 4. Many other embodiments are possible. Like level 1 security, steps implemented in level 2 security may depend on the configuration specified in configuration module 310. Level 2 security may be implemented concurrently with or prior to implementation of level 1 security. In the embodiment illustrated in method 400, verification component 341 may be implemented in response to detection of an ad by ad detection module 320 and passage of the ad through level 1 security module 330, where, for example, passage occurs because the ad is not blacklisted or because level 1 security module 330 is disabled in the configuration. If the ad fails to meet trusted or rating requirements specified in the configuration of security level 2 or if the ad's certificate is not validated (e.g. because it is not authentic or is expired) then ad performance may be denied in step 442. In this embodiment, level 2 security configuration in step 516 may specify that ad performance is denied for any unqualified ad that fails to meet required trust and/or rating levels or fails verification. If the ad meets trust or rating level requirements, e.g., by verifying the authenticity of the ad's certificate certifying trust and/or rating levels, then method 400 proceeds to level 3 security module 350.

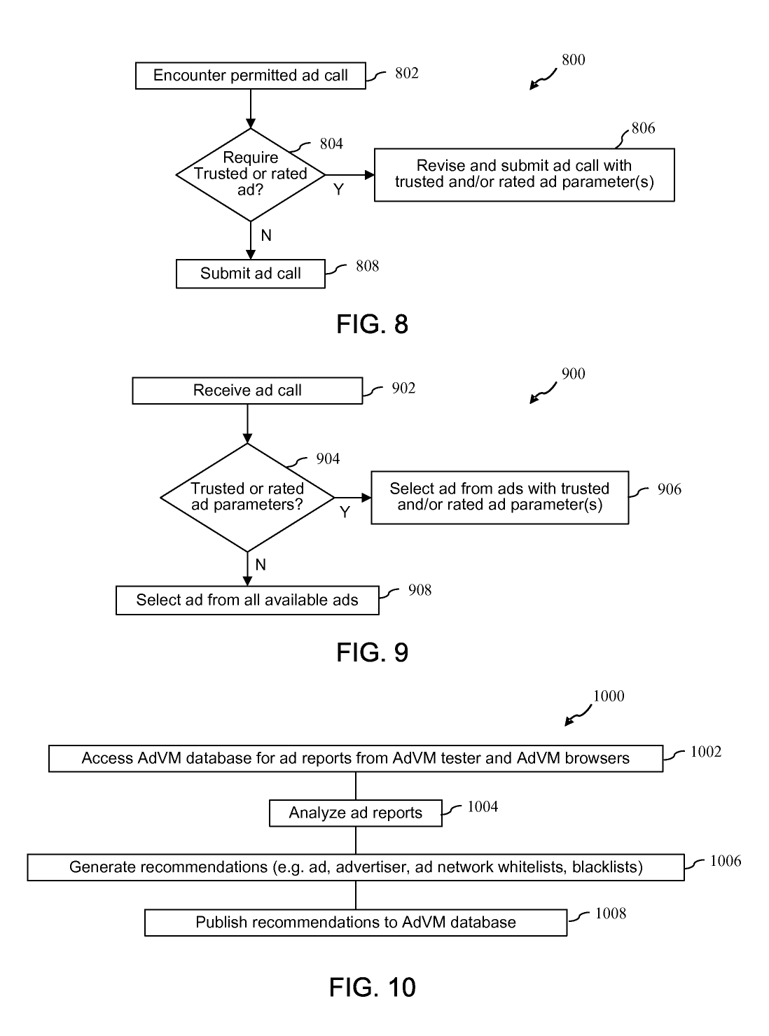

In some embodiments, level 2 security module 340 may be configured to request and/or require trusted and/or rated ads in accordance with configuration step 516 or other configuration step. FIG. 8 is a flowchart of an example method 800 of requiring trusted or rated ads in accordance with embodiments described herein. In step 802, an ad call is encountered. Depending on the embodiment, such an ad call may have already satisfied the configured requirements of permission component 331 in level 1 security module 330, e.g., by determining that the ad call is a permitted ad call because it is not blacklisted. In step 804, a decision is made whether a trusted and/or rated ad is required. This may be determined from the configuration per step 516 or other configuration step. If a trusted or rated ad is not required then in step 808 the permitted ad call may be submitted as is, such as to ad network A 104 or AdVM ad network 210 for ad selection and retrieval. If a trusted or rated ad is required, then in step 806 the permitted ad call may be revised and submitted with trusted and/or rated ad parameter(s) specified in configuration step 516 or other configuration step. Method 800 or a similar method may alternatively or additionally be implemented by AdVM publishers A-N 202-204 to modify and/or create new ad calls, including those embedded in content, by adding parameters requiring trusted and/or rated ads. Publishers may publish their commitment to safe advertising by publishing notice(s) letting end-users know they only serve rated and/or trusted ads and/or otherwise participate in or support one or more AdVM ad security levels.

Level 3 security module 350 comprises sandbox component 351, monitoring component 352, enforcement component 353, notification component 354 and reporting component 355. One example of steps that may be performed by components 351-355 in level 3 security module 350 is illustrated in FIG. 4. Many other embodiments are possible. Like level 1 and level 2 security, steps implemented in level 3 security may depend on the configuration specified in configuration module 310. Level 3 security may be implemented concurrently with or prior to implementation of level 1 and level 2 security. In the embodiment illustrated in method 400, sandbox component 351 may be implemented in response to detection of an ad by ad detection module 320, passage of the ad through level 1 security module 330 and passage of the ad through level 2 security module 340, where, for example, passage occurs because the ad is not blacklisted and its certified trust or rating level is verified or because level 1 security module 330 and/or level 2 security module 340 is/are disabled in the configuration. In method 400, sandboxing is enabled in step 518. In step 451a, sandbox component 351 may sandbox an ad to isolate its performance, e.g., by wrapping ad creatives in a configurable JavaScript function before executing it. As previously noted, a publisher may provide sandboxed ads. However, a configuration of AdVM browser 206 may be more restrictive than a sandbox created by a publisher. If a publisher's sandbox is configurable by AdVM browser 206 or is more restrictive than a sandbox configuration in AdVM browser 206 then it could be used by level 3 security module 350. In step 451b, the ad may be performed in the sandbox with only authorized external interactions. Ad performance may comprise execution of ad creative code and content. In method 400, monitoring is enabled in step 518.

In step 452, monitoring component 352 may monitor parameters it is configured to monitor during ad performance, i.e., during runtime. Monitoring may occur before and during ad performances. Monitoring may comprise monitoring abuse indicators in ad code, such as the existence of JavaScript eval function in ad code, suspicious or blacklisted IP addresses, domains, invisible iFrames, code that analyzes user environment, clicking on ads or other events used by the ad. Monitoring may also monitor CPU usage, network bandwidth usage, memory usage, network accesses and addresses, access to cookies, access to a document object model (DOM). Monitoring component 352 may actively or passively monitor ad performance. For example, parameters may be recorded an used in informational notices provided to an end-user, perhaps with an option to manually intervene, or monitored parameters may be used for automated action, such as to restrict performance to prevent rule violations. In step 453, enforcement component 353 may enforce the pre-performance and performance parameters or rules defined during configuration of AdVM browser 206. Enforcement component 353 may, for example, restrict or prohibit: use of JavaScript eval functions or other string manipulations and code obfuscations, access to blacklisted ads, IP addresses or domains, invisible iFrames, code that analyzes user environment, inadvertent clicking on ads or other events used by the ad, access to cookies, access to a document object model (DOM) and may restrict CPU usage, network bandwidth usage and memory usage. Other parameter restrictions or prohibitions may be enforced by enforcement component 353. Enforcement component 353 responds to actual or attempted violations in accordance with the configuration specified by step 518e. For example, enforcement component 353 may respond by denying or terminating performance of an ad or permitting performance to start or continue and simply prevent violations.

In step 454, notification component 354 may notify an end-user of AdVM browser 206 in accordance with the configuration specified in step 512. For example, end-user may be notified visually and/or audibly in the event of a pre-performance violation, performance violation, enforcement action, etc. A window may provide summary and detailed explanations for an end-user. In step 455, reporting component 355 may report violations to AdVM database 220 in accordance with the configuration specified by step 518c. Step 455 assumes that in step 518c, reporting (e.g. to AdVM database 220) is enabled. A report may contain information about all abuses (e.g. pre-performance and performance abuses) by an ad call and ad content, including abusive code. In some embodiments, AdVM publishers may provide code associated with ads that provides a user interface (e.g. a clickable button or link) with ads for end-users to selectively report abuse incidents. Interaction with (e.g. clicking) the user interface may permit end-users to and/or their AdVM browsers to transmit abuse reports, perhaps including monitored information collected by AdVM browser A-N 206-208. Alternatively or additionally, AdVM browsers may provide a user interface associated with detected ads for end-users to report abuse incidents. This could be part of a sandbox an ad is executing in.

Embodiments may vary from the examples provided herein. Various embodiments may comprise all, fewer or additional elements, modules, components, steps, features and functionality illustrated and discussed in and for FIGS. 2-11. Moreover, in some embodiments, some elements, modules, components, steps, features and functionality illustrated and discussed in and for FIGS. 2-11 may be merged or split. In some embodiments, one or more steps may not be performed. Moreover, additional or alternative steps may be performed in some embodiments.

Elements, modules, components, steps, features and functionality illustrated and discussed in and for FIGS. 2-11 may be implemented in hardware, software, firmware, or any combination thereof. For example, AdVM browser A 206, AdVM browser N 208, AdVM publisher A 202, AdVM publisher N 204, AdVM Ad Network 210, AdVM ad server 212, AdVM content server 214, AdVM tester 216, AdVM profiler 218, AdVM database 220, AdVM AQCA 222 and all other elements, modules, components, steps, features and functionality illustrated and discussed in and for FIGS. 2-11, including but not limited to each step of each flowchart discussed herein, may be implemented as computer program code configured to be executed in one or more processors and/or may be implemented as hardware logic/electrical circuitry.

### III. Example Computer System Implementation

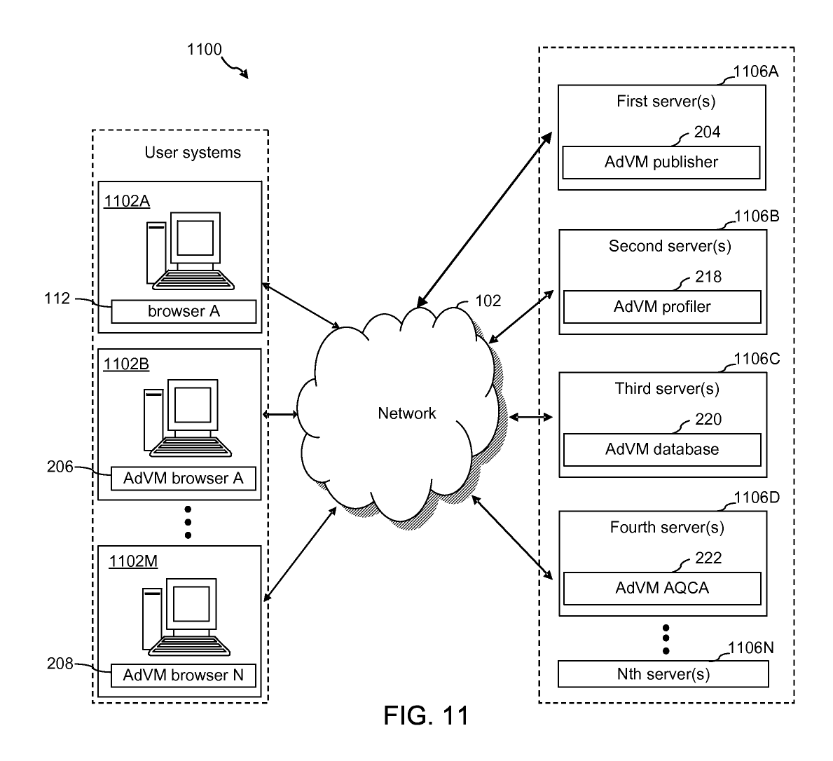

FIG. 11 is a block diagram of an example computer system 1100 in accordance with an embodiment described herein. Generally speaking, computer system 1100 operates to provide content to users in response to requests (e.g., hypertext transfer protocol (HTTP) requests) that are provided by the users. The content may be in the form of web pages, images, videos, other types of files, output of executables, advertisements, etc. and/or links thereto. In accordance with example embodiments, computer system 1100 is configured to protect end-users from malware using one or more features provided by AdVM system components illustrated in FIG. 2 implemented in one or more user systems 1102A-M and/or servers 1106A-N.

As shown in FIG. 11, computer system 100 includes a plurality of user systems 1102A-1102M, a network 102, and a plurality of servers 1106A-1106N. Communication among user systems 1102A-1102M and servers 1106A-1106N is carried out over network 102 using well-known network communication protocols. Network 102 may be a wide-area network (e.g., the Internet), a local area network (LAN), another type of network, or a combination thereof.

User systems 1102A-1102M are computers or other processing systems, each including one or more processors, that are capable of communicating with servers 1106A-1106N. User systems 1102A-1102M are capable of directly and indirectly accessing sites (e.g., web sites) hosted by servers 1106A-1106N, including search engine web sites, so that user systems 1102A-1102M may access content that is available via the sites, including search results. User systems 1102A-1102M may be configured to provide requests (e.g., hypertext transfer protocol (HTTP) requests) to servers 1106A-1106N for requesting content stored on (or otherwise accessible via) servers 1106A-1106N. For instance, a user may initiate a request for content using a client (e.g., a web crawler, a web browser, a non-web-enabled client, etc.) deployed on a user system 1102A-M that is owned by or otherwise accessible to the user. User systems 1102A-1102M may variously use AdVM and non-AdVM browsers to search for, access, download and browse published content. For example, an end-user of first user system 1102A uses browser A 112, an end-user of second user system 1102B uses AdVM browser A 206 and an end-user of third user system 1102M uses AdVM browser N 208 to search for, access, download and browse published content.

Servers 1106A-1106N are computers or other processing systems, each including one or more processors, that are capable of communicating with user systems 1102A-1102M. Servers 1106A-1106N may host, for example, content providers (i.e. content sources), content publishers, ad networks, ad servers, ad content servers, ad exchanges, ad profilers, advertisers (i.e. ad sources), content, ad testers, ad rating agencies and other online participants. For example, first server(s) 1106A hosts AdVM publisher 204, second server(s) 1106B hosts AdVM profiler 218, third server(s) 1106C hosts AdVM database 220 and fourth server(s) 1106D hosts AdVM AQCA. Servers 1106A-1106N may be configured to host respective sites (e.g., web sites) so that the sites are accessible to users of user systems 1102A-1102M. Servers 1106A-1106N are further configured to provide content and ads or ad calls to users in response to receiving requests (e.g., HTTP requests) from the users.

It will be recognized that any one or more user systems 1102A-1102M may communicate with any one or more servers 1106A-1106N. Although user systems 1102A-1102M are depicted as desktop computers in FIG. 11, persons skilled in the relevant art(s) will appreciate that user systems 1102A-1102M may include any client-enabled system or device, including but not limited to a laptop computer, a tablet computer, a personal digital assistant, a cellular telephone, etc. It will be recognized that although some operations are described herein as being performed by a user for ease of discussion, such operations may be performed by a respective user system 1102A-M.

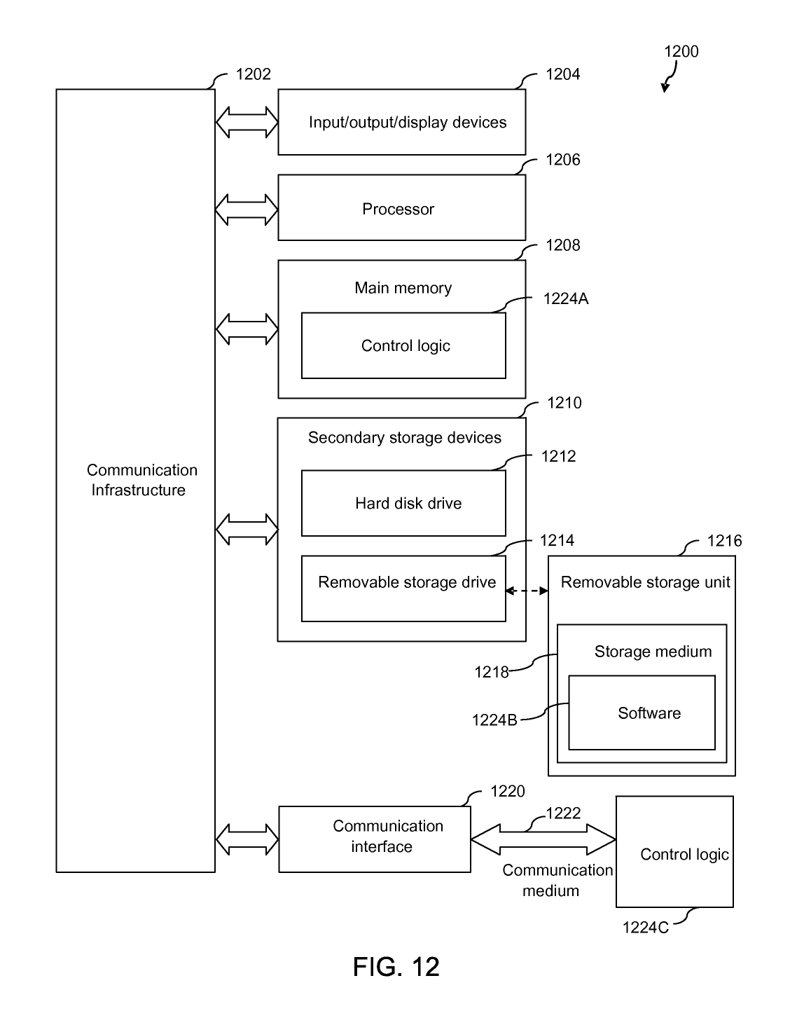

FIG. 12 is a block diagram of a computer in which embodiments may be implemented. Embodiments described herein, including systems, methods/processes, machines, apparatuses, may be implemented using well known computers, such as computer 1200 shown in FIG. 12. For example, one or more computers 1200 may be used to implement each user system 1102A-1102M, each server1106A-1106N, AdVM browser A 206, AdVM browser N 208, AdVM publisher A 202, AdVM publisher N 204, AdVM Ad Network 210, AdVM ad server 212, AdVM content server 214, AdVM tester 216, AdVM profiler 218, AdVM database 220, AdVM AQCA 222 and all other elements, modules, components, steps, features and functionality illustrated and discussed in and for FIGS. 2-11, including but not limited to each step of each flowchart discussed herein.

Computer 1200 can be any commercially available and well known computer capable of performing the functions described herein, such as computers available from International Business Machines, Apple, Sun, HP, Dell, Cray, etc. Computer 1200 may be any type of computer, including a desktop computer, a server, etc.

As shown in FIG. 12, computer 1200 includes one or more processors (e.g., central processing units (CPUs)), such as processor 1206. Processor 1206 may include each module discussed herein; or any portion or combination thereof, for example, though the scope of the embodiments is not limited in this respect. Processor 1206 is connected to a communication infrastructure 1202, such as a communication bus. In some embodiments, processor 1206 can simultaneously operate multiple computing threads.

Computer 1200 also includes a primary or main memory 1208, such as a random access memory (RAM). Main memory has stored therein control logic 1224A (computer software), and data.

Computer 1200 also includes one or more secondary storage devices 1210. Secondary storage devices 1210 include, for example, a hard disk drive 1212 and/or a removable storage device or drive 1214, as well as other types of storage devices, such as memory cards and memory sticks. For instance, computer 1200 may include an industry standard interface, such as a universal serial bus (USB) interface for interfacing with devices such as a memory stick. Removable storage drive 1214 represents a floppy disk drive, a magnetic tape drive, a compact disk drive, an optical storage device, tape backup, etc.

Removable storage drive 1214 interacts with a removable storage unit 1216. Removable storage unit 1216 includes a computer useable or readable storage medium 1218 having stored therein computer software 1224B (control logic) and/or data. Removable storage unit 1216 represents a floppy disk, magnetic tape, compact disc (CD), digital versatile disc (DVD), Blue-ray disc, optical storage disk, memory stick, memory card, or any other computer data storage device. Removable storage drive 1214 reads from and/or writes to removable storage unit 1216 in a known manner.

Computer 1200 also includes input/output/display devices 1204, such as monitors, keyboards, pointing devices, etc.

Computer 1200 further includes a communication or network interface 1220. Communication interface 1220 enables computer 1200 to communicate with remote devices. For example, communication interface 1220 allows computer 1200 to communicate over communication networks or mediums 1222 (representing a form of a computer useable or readable medium), such as local area networks (LANs), wide area networks (WANs), the Internet, etc. Network interface 1220 may interface with remote sites or networks via wired or wireless connections. Examples of communication interface 1222 include but are not limited to a modem, a network interface card (e.g., an Ethernet card), a communication port, a Personal Computer Memory Card International Association (PCMCIA) card, etc.

Control logic 1224C may be transmitted to and from computer 1200 via the communication medium 1222.

Any apparatus or manufacture comprising a computer useable or readable medium having control logic (e.g. software, firmware) stored therein is referred to herein as a computer program product, program storage device, computer readable medium and the like. This includes, but is not limited to, computer 1200, main memory 1208, secondary storage devices 1210, and removable storage unit 1216. Such computer program products, having control logic stored therein that, when executed by one or more data processing devices, cause such data processing devices to operate as described herein, represent embodiments of the invention. For example, each of the elements of example user systems 1102A-1102M and servers 1106A-1106N, AdVM browser A 206, AdVM browser N 208, AdVM publisher A 202, AdVM publisher N 204, AdVM Ad Network 210, AdVM ad server 212, AdVM content server 214, AdVM tester 216, AdVM profiler 218, AdVM database 220, AdVM AQCA 222 and all other elements, modules, components, steps, features and functionality illustrated and discussed in and for FIGS. 2-11, including but not limited to each step of each flowchart discussed herein, can be implemented as control logic that may be stored on a computer useable medium or computer readable medium, which can be executed by one or more processors to operate as described herein.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

The proper interpretation of subject matter described and claimed herein is limited to patentable subject matter under 35 U.S.C. §101. As described and claimed herein, a method is a process defined by 35 U.S.C. §101. As described and claimed herein, each of a device, apparatus, machine, system, computer, module, method, component, computer readable media, media, etc. is both described and claimed in all implementation embodiments as one or more of a process, machine or manufacture defined by 35 U.S.C. §101.

What is claimed is:

1. A method of providing advertisement (ad) security comprising at least the following steps implemented by a computer configured to browse content:
requesting content;
receiving the content and an ad or an ad call;
detecting the ad, or detecting the ad call and calling the ad;
performing the ad in a sandbox;
monitoring performance of the ad in the sandbox; and
reporting abusive performance of the ad to an ad database that receives reports of abusive performance of a plurality of ads from a plurality of computers configured to browse content.

2. The method of claim 1, further comprising:
isolating the ad in a sandbox.

3. The method of claim 2, further comprising:
configuring the sandbox.

4. The method of claim 3, further comprising:
configuring the sandbox to automatically report abusive performance by the ad.

5. The method of claim 3, further comprising:
configuring the sandbox to restrict performance of the ad.

6. The method of claim 5, further comprising:
configuring the sandbox to restrict access by the ad to at least one of: cookies, a document object model (DOM), bandwidth, a processor, a memory.

7. The method of claim 3, further comprising:
configuring the sandbox to prevent inadvertent clicking of the ad.

8. The method of claim 3, further comprising:
configuring the sandbox to require the ad to be a trusted ad.

9. The method of claim 8, further comprising:
configuring the sandbox to require the trusted ad to have at least one of a minimum, maximum and specific rating.

10. The method of claim 9, wherein the at least one of a minimum, maximum and specific rating comprises at least one of content rating and quality rating.

11. The method of claim 8, further comprising:
verifying the ad is a trusted ad by authenticating a digital signature of the ad.

12. The method of claim 1, further comprising:
accessing a blacklist or a whitelist of at least one of ads, advertisers and domains maintained by the ad base;
comparing the ad to the blacklist or whitelist; and
using the blacklist or whitelist to, respectively, deny or allow performance of the ad based on the comparison.

13. The method of claim 1, wherein an ad tag in the content marks the ad or the ad call and detecting the ad or the ad call comprises detecting the ad tag.

14. The method of claim 1, wherein the method of providing ad security is provided by a browser application on the computer or a plug-in or an extension to the browser application on the computer.

15. The method of claim 3, wherein placing the ad in a sandbox comprises wrapping the ad in a JavaScript function configured by the configuring of the sandbox.

16. The method of claim 1, wherein the ad database receives reports of abusive performance of a plurality of ads from an ad testing computer.

17. A system for providing advertising security comprising:
an ad testing computer that sandboxes ads during ad performance testing;
a plurality of audience computers that sandbox ads during ad performance; and
an ad database that receives reports of abusive performance of a plurality of ads from the ad testing computer and the plurality of audience computers.

18. The system of claim 17, further comprising:
a publishing computer that performs at least one of:
declaring an ad zone in content to assist an audience computer in detecting and sandboxing the ad;
requesting a trusted ad or rejecting an untrusted ad to be provided with the content;
verifying an ad to be provided with the content is a trusted ad.

19. The system of claim 17, further comprising:
an ad qualification computer that qualifies ads, wherein the plurality of audience computers are configurable to require qualified ads.

20. The system of claim 17, further comprising:
an ad network computer configured to differentiate between and select among trusted and untrusted ads or rated and unrated ads in response to an ad call that specifies at least one of a trusted ad and an ad rating level.

21. A computer readable medium comprising computer-executable instructions for an advertising security module that, when executed by an audience computer, provides advertisement (ad) security for the audience computer comprising:
permitting user configuration to selectively monitor performance of the ad and to report or restrict performance of the ad;
detecting an ad or a call for the ad in publisher content;
sandboxing the ad to create a sandboxed ad;
executing the sandboxed ad; and
monitoring performance of the ad and reporting or restricting performance of the sandboxed ad according to the configuration.
